(19) United States
(12) Patent Application Publication
(10) Pub. No.: US 2026/0361342 A1
(43) Pub. Date: Nov. 12, 2026

(54) ON-OFF PATTERNS FOR PANELS AND CONTROLLERS ASSOCIATED WITH RECONFIGURABLE INTELLIGENT SURFACES

(71) Applicant: QUALCOMM Incorporated, San Diego, CA (US)

(72) Inventors: Zhikun WU, Beijing (CN); Ahmed ELSHAFIE, San Diego, CA (US); Wanshi CHEN, San Diego, CA (US); Hyojin LEE, San Diego, CA (US); Yu ZHANG, San Diego, CA (US)

(21) Appl. No.: 19/135,228

(22) PCT Filed: Feb. 16, 2023
(86) PCT No.: PCT/CN2023/076435

§ 371 Date: Jun. 3, 2025

(51) Int. Cl. H04B 7/04; H04W 76/28

(52) U.S. Cl. CPC H04B 7/04013; H04W 76/28

(57) ABSTRACT

Various aspects of the present disclosure generally relate to wireless communication. In some aspects, a device may transmit a configuration that indicates one or multiple on-off patterns, the one or multiple on-off patterns being associated with one or more of: one or more panels of a reconfigurable intelligent surface (RIS), one or more sub-panels of the RIS, or an RIS controller. The device may receive an indication based at least in part on a receipt of the configuration that indicates the one or multiple on-off patterns. Numerous other aspects are described.

### FIELD OF THE DISCLOSURE

Aspects of the present disclosure generally relate to wireless communication and to techniques and apparatuses for on-off patterns for panels and controllers associated with reconfigurable intelligent surfaces (RISs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a device. The apparatus may include a memory and one or more processors coupled to the memory. The one or more processors may be configured to transmit a configuration that indicates one or multiple on-off patterns, the one or multiple on-off patterns being associated with one or more of: one or more panels of a reconfigurable intelligent surface (RIS), one or more sub-panels of the RIS, or an RIS controller. The one or more processors may be configured to receive an indication based at least in part on a receipt of the configuration that indicates the one or multiple on-off patterns.

Some aspects described herein relate to an apparatus for wireless communication at an RIS controller. The apparatus may include a memory and one or more processors coupled to the memory. The one or more processors may be configured to receive a configuration that indicates one or multiple on-off patterns, the one or multiple on-off patterns being associated with one or more of: one or more panels of an RIS associated with the RIS controller, one or more sub-panels of the RIS, or the RIS controller. The one or more processors may be configured to configure the RIS with the one or multiple on-off patterns based at least in part on the configuration that indicates the one or multiple on-off patterns.

Some aspects described herein relate to a method of wireless communication performed by a device. The method may include transmitting a configuration that indicates one or multiple on-off patterns, the one or multiple on-off patterns being associated with one or more of: one or more panels of an RIS, one or more sub-panels of the RIS, or an RIS controller. The method may include receiving an indication based at least in part on a receipt of the configuration that indicates the one or multiple on-off patterns.

Some aspects described herein relate to a method of wireless communication performed by an RIS controller. The method may include receiving a configuration that indicates one or multiple on-off patterns, the one or multiple on-off patterns being associated with one or more of: one or more panels of an RIS associated with the RIS controller, one or more sub-panels of the RIS, or the RIS controller. The method may include configuring the RIS with the one or multiple on-off patterns based at least in part on the configuration that indicates the one or multiple on-off patterns.

Some aspects described herein relate to a non-transitory computer-readable medium that stores a set of instructions for wireless communication by a device. The set of instructions, when executed by one or more processors of the device, may cause the device to transmit a configuration that indicates one or multiple on-off patterns, the one or multiple on-off patterns being associated with one or more of: one or more panels of an RIS, one or more sub-panels of the RIS, or an RIS controller. The set of instructions, when executed by one or more processors of the device, may cause the device to receive an indication based at least in part on a receipt of the configuration that indicates the one or multiple on-off patterns.

Some aspects described herein relate to a non-transitory computer-readable medium that stores a set of instructions for wireless communication by an RIS controller. The set of instructions, when executed by one or more processors of the RIS controller, may cause the RIS controller to receive a configuration that indicates one or multiple on-off patterns, the one or multiple on-off patterns being associated with one or more of: one or more panels of an RIS associated with the RIS controller, one or more sub-panels of the RIS, or the RIS controller. The set of instructions, when executed by one or more processors of the RIS controller, may cause the RIS controller to configure the RIS with the one or multiple on-off patterns based at least in part on the configuration that indicates the one or multiple on-off patterns.

Some aspects described herein relate to an apparatus for wireless communication. The apparatus may include means for transmitting a configuration that indicates one or multiple on-off patterns, the one or multiple on-off patterns being associated with one or more of: one or more panels of an RIS, one or more sub-panels of the RIS, or an RIS controller. The apparatus may include means for receiving an indication based at least in part on a receipt of the configuration that indicates the one or multiple on-off patterns.

Some aspects described herein relate to an apparatus for wireless communication. The apparatus may include means for receiving a configuration that indicates one or multiple on-off patterns, the one or multiple on-off patterns being associated with one or more of: one or more panels of an RIS associated with the apparatus, one or more sub-panels of the RIS, or the RIS controller. The apparatus may include means for configuring the RIS with the one or multiple on-off patterns based at least in part on the configuration that indicates the one or multiple on-off patterns.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a reconfigurable intelligent surface (RIS) implementation, in accordance with the present disclosure.

FIG. 5 is a diagram illustrating examples of RIS architectures, in accordance with the present disclosure.

FIGS. 6-11 are diagrams illustrating examples associated with on-off patterns for panels and controllers associated with RISs, in accordance with the present disclosure.

FIGS. 12A and 12B are diagrams illustrating examples associated with on-off patterns for panels and controllers associated with RISs, in accordance with the present disclosure.

FIGS. 13-14 are diagrams illustrating example processes associated with on-off patterns for panels and controllers associated with RISs, in accordance with the present disclosure.

FIGS. 15-16 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

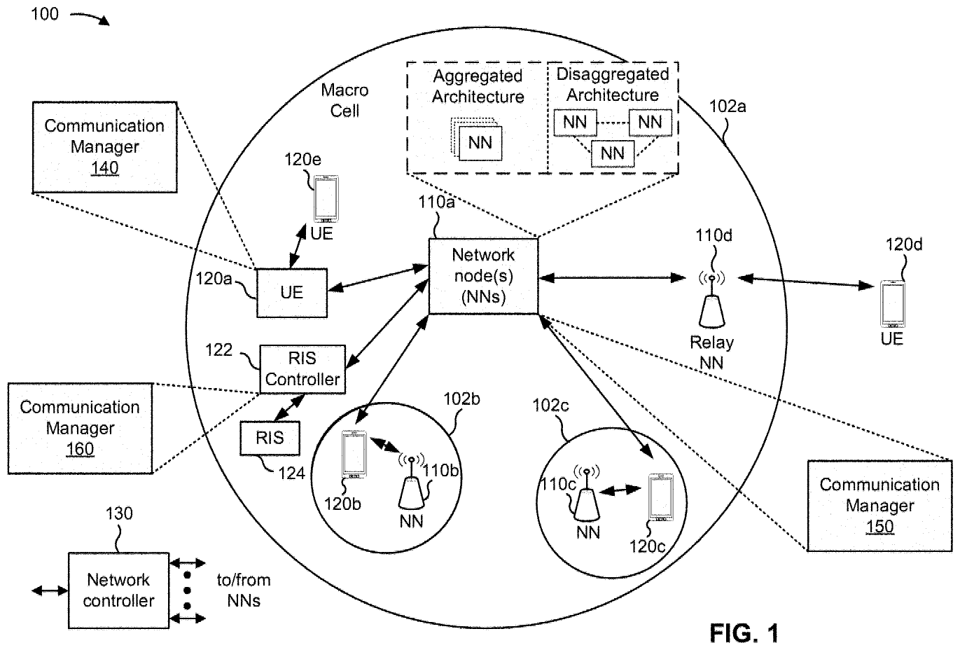

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a device (e.g., UE 120 or network node 110) may include a communication manager 140 or a communication manager 150. As described in more detail elsewhere herein, the communication manager 140 or the communication manager 150 may transmit a configuration that indicates multiple on-off patterns, the one or multiple on-off patterns being associated with one or more of: one or more panels of a reconfigurable intelligent surface (RIS), one or more sub-panels of the RIS, or an RIS controller; and receive an indication based at least in part on a receipt of the configuration that indicates the one or multiple on-off patterns. Additionally, or alternatively, the communication manager 140 or the communication manager 150 may perform one or more other operations described herein.

In some aspects, an RIS controller (e.g., RIS controller 122) may include a communication manager 160. As described in more detail elsewhere herein, the communication manager 160 may receive a configuration that indicates one or multiple on-off patterns, the one or multiple on-off patterns being associated with one or more of: one or more panels of an RIS associated with the RIS controller, one or more sub-panels of the RIS, or the RIS controller; and configure the RIS with the one or multiple on-off patterns based at least in part on the configuration that indicates the one or multiple on-off patterns. Additionally, or alternatively, the communication manager 160 may perform one or more other operations described herein.

As indicated above, FIG. 1 is provided as an example. Other examples may differ from what is described with regard to FIG. 1.

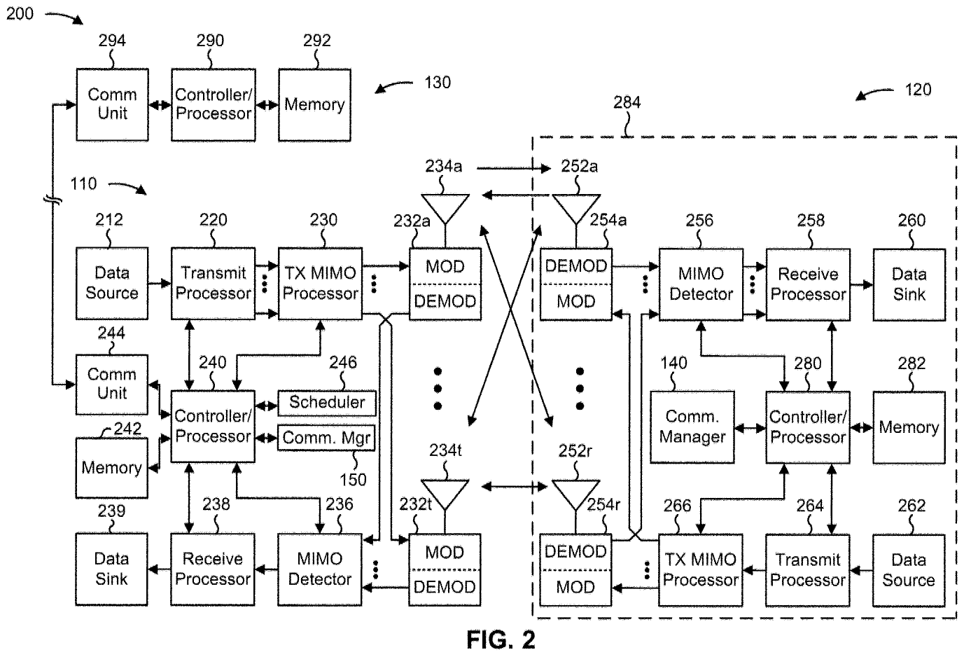

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

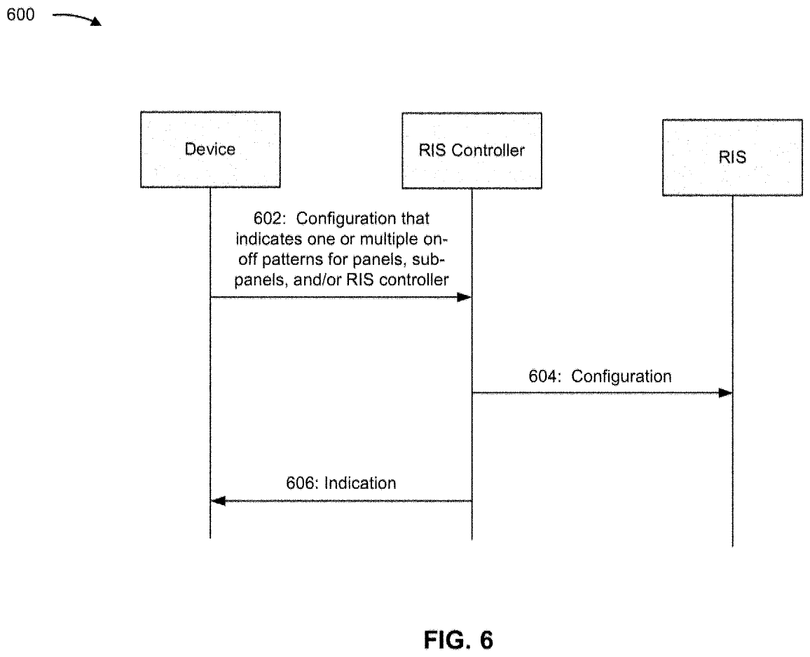

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-11, 12A, 12B, and 16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-11, 12A, 12B, and 16).

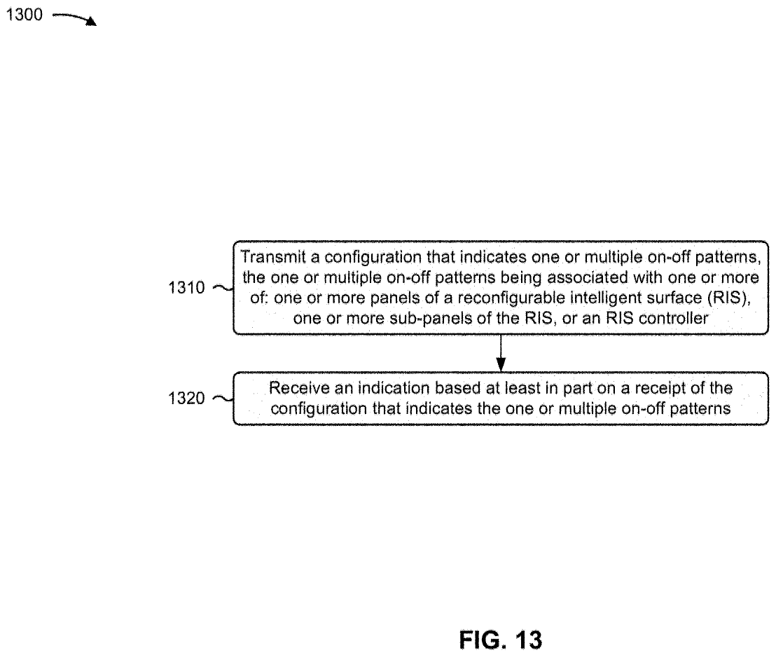

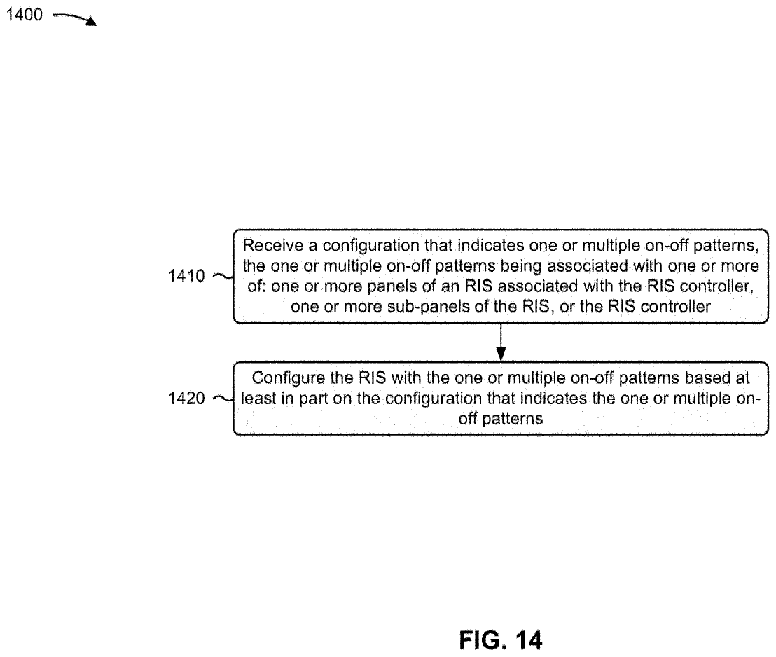

The controller/processor 240 of the network node 110, the controller/processor 280 of the UE 120, and/or any other component(s) of FIG. 2 may perform one or more techniques associated with on-off patterns for panels and controllers associated with RISs, as described in more detail elsewhere herein. In some aspects, the device described herein is the network node 110, is included in the network node 110, or includes one or more components of the network node 110 shown in FIG. 2. In some aspects, the device described herein is the UE 120, is included in the UE 120, or includes one or more components of the UE 120 shown in FIG. 2. In some aspects, the RIS controller described herein includes one or more components of the network node 110 and/or the UE 120 shown in FIG. 2. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a device (e.g., UE 120 or network node 110) includes means for transmitting a configuration that indicates one or multiple on-off patterns, the one or multiple on-off patterns being associated with one or more of: one or more panels of an RIS, one or more sub-panels of the RIS, or an RIS controller (e.g., using controller/processor 280, transmit processor 264, TX MIMO processor 266, modem 254, antenna 252, memory 282, or the like, or using controller/processor 240, transmit processor 220, TX MIMO processor 230, modem 232, antenna 234, memory 242, or the like); and/or means for receiving an indication based at least in part on a receipt of the configuration that indicates the one or multiple on-off patterns (e.g., using antenna 252, modem 254, MIMO detector 256, receive processor 258, controller/processor 280, memory 282, or the like, or using antenna 234, modem 232, MIMO detector 236, receive processor 238, controller/processor 240, memory 242, or the like). In some aspects, the means for the device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an RIS controller (e.g., RIS controller 122) includes means for receiving a configuration that indicates one or multiple on-off patterns, the one or multiple on-off patterns being associated with one or more of: one or more panels of an RIS associated with the RIS controller, one or more sub-panels of the RIS, or the RIS controller; and/or means for configuring the RIS with the one or multiple on-off patterns based at least in part on the configuration that indicates the one or multiple on-off patterns. In some aspects, the means for the RIS controller to perform operations described herein may include, for example, one or more of communication manager 160, transmit processor 220, TX MIMO processor 230, modem 232, antenna 234, MIMO detector 236, receive processor 238, controller/processor 240, memory 242, or scheduler 246. In some aspects, the means for the RIS controller to perform operations described herein may include, for example, one or more of communication manager 160, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

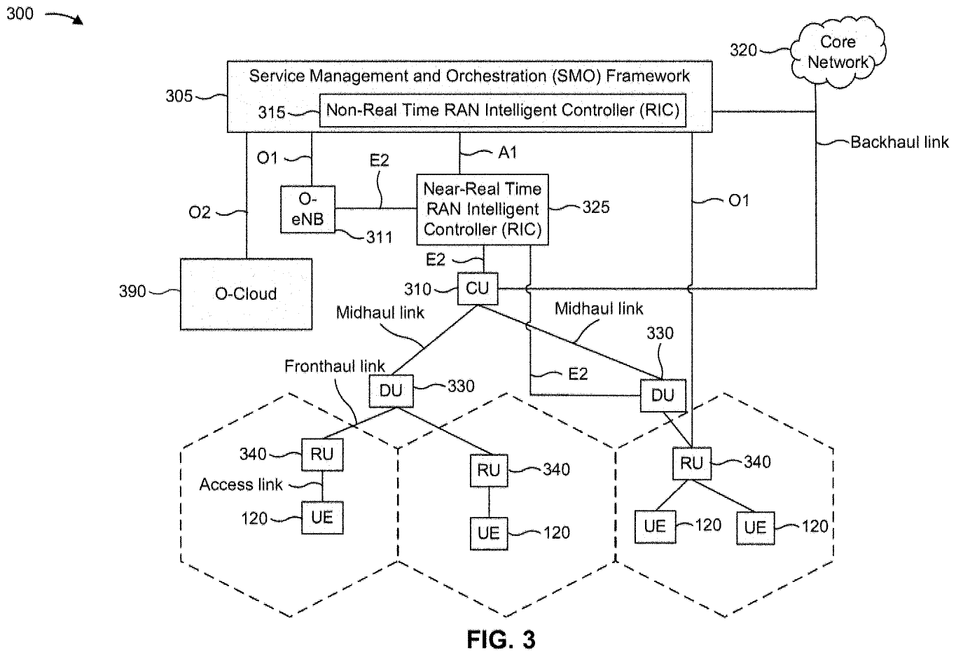

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1interface) the Near-RT RIC 325. The Near-RT RIC 325 may be configured to include a logical function that enables near-real-time control and optimization of RAN elements and resources via data collection and actions over an interface (such as via an E2interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

An RIS may be a network element that is employed to extend an NR coverage with negligible power consumption. The RIS may be a mirror-like near passive device. The RIS may include X elements in a horizontal direction and Y elements in a vertical direction. In other words, the RIS may be comprised of X by Y elements. Each element may reflect a waveform that is incident to a surface of the element. The waveform may be transmitted by a network node or a UE. Each element may reflect the waveform based at least in part on a reflection coefficient, such that the waveform may be reflected to a direction. The waveform that strikes the element may be an incident waveform, and the waveform that is reflected from the element may be a reflected waveform. The direction toward which the waveform is reflected may be a function of the reflection coefficient and/or a phase associated with the element that reflects the waveform.

The RIS may be a two-dimensional antenna array composed of individual scattering elements. The scattering elements may be manufactured by reconfigurable meta-surfaces, which may fully control phase shifts incurred by the individual scattering elements. The RIS may be associated with a simple structure and a relatively low cost, and may be deployed in cellular systems to improve overall system performance.

As an example, a network node may attempt to transmit a downlink transmission to a UE. However, the network node and the UE may be separated by a blockage, which may prevent the downlink transmission from being received by the UE. In this scenario, an RIS may be employed in proximity to the blockage. The RIS may include a plurality of elements that reflect the downlink transmission from the network node in a direction toward the UE. As a result, the network node may effectively perform downlink transmissions to the UE via the RIS, even though the blockage may be present between the network node and the UE.

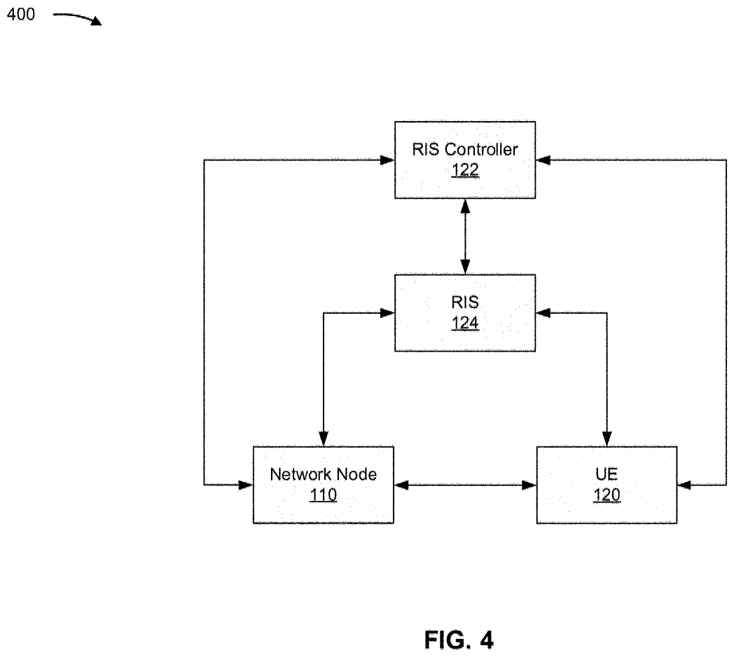

FIG. 4 is a diagram illustrating an example 400 of an RIS implementation, in accordance with the present disclosure.

As shown in FIG. 4, an RIS 124 may communicate with an RIS controller 122. The RIS 124 may include a panel (e.g., an RIS panel) with RIS elements. RIS element characteristics (e.g., phase shift) may be configurable. The panel may be further divided into sub-panels (e.g., RIS sub-panels). The RIS controller 122 (e.g., a legacy UE) may receive an RIS configuration from a network (e.g., a network node 110 or a UE 120). The RIS controller 122 may configure the RIS 124 based at least in part on the RIS configuration. The RIS controller 122 may connect to more than one RIS 124. In some cases, the RIS controller 122 may connect to only one RIS 124. The RIS 124 may be associated with an on-off state. A power supply to the RIS 124 (e.g., the panel and/or the RIS elements) may be set to on or off. When on, the RIS 124 may reflect signals (or reflect signals with a changeable direction). When off, the RIS 124 may be unable to reflect signals (or may reflect signals with a preconfigured direction). The RIS controller 122 may be associated with an on-off state. A power supply to the RIS controller 122 may be set to on or off. When off, the RIS controller 122 may be unable to transmit or receive information with the network. Further, when off, the RIS controller 122 may be unable to change the RIS configuration associated with the RIS 124.

As indicated above, FIG. 4 is provided as an example. Other examples may differ from what is described with regard to FIG. 4.

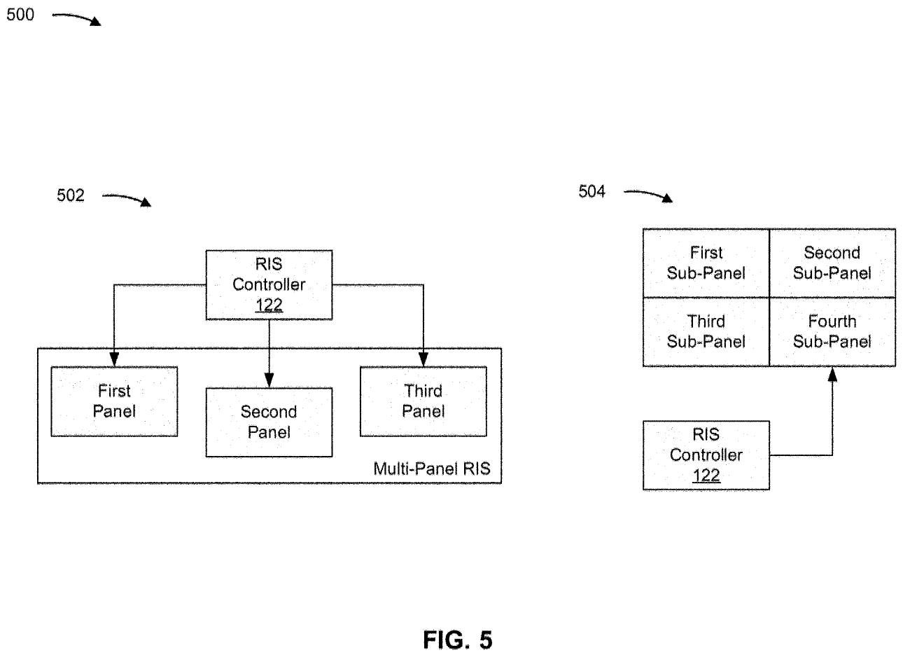

FIG. 5 is a diagram illustrating examples 500 of RIS architectures, in accordance with the present disclosure.

As shown by reference number 502, a multi-panel RIS may be associated with an RIS controller 122. The multi-panel RIS may include multiple panels. The RIS controller 122 may connect to the multiple panels. Each panel may be capable of performing an individual beamforming. Each panel may be individually configured by the RIS controller 122. Different panels may work in different carriers. Different panels may point in different directions.

As shown by reference number 504, a multi-sub-panel RIS may be associated with an RIS controller 122. The multi-sub-panel RIS may include a single panel. The single panel may be further divided into multiple sub-panels. Each sub-panel may be individually controlled and configured by the RIS controller 122. Different sub-panels may point in the same direction.

As an example, regarding individually controlled sub-panels, a first sub-panel may have ten elements and a second sub-panel may have ten elements. The first sub-panel may be configured to a first beam and the second sub-panel may be configured to a second beam. In order to generate the first beam, the first sub-panel may need to configure a phase shift to a first element of the first sub-panel, a second element of the first sub-panel, and so on, up to a tenth element of the first sub-panel. Alternatively, a plurality of elements (e.g., all elements) in the first sub-panel may be configured to the first phase shift. A plurality of elements (e.g., all elements) in the second sub-panel may be configured to the second phase shift.

As indicated above, FIG. 5 is provided as an example. Other examples may differ from what is described with regard to FIG. 5.

Discontinuous reception (DRX) is a mechanism in which a UE may enter a sleep mode for a certain period of time, and then may wake up for another period of time. The UE, when in the sleep mode, may not monitor a physical downlink control channel (PDCCH), thereby realizing a power saving. DRX may be applied in an RRC connected mode or an RRC idle mode. A connected mode DRX (C-DRX) may include a short DRX cycle and a long DRX cycle. The short DRX cycle may be optional. An idle mode DRX (I-DRX) may include an on stage and an off stage, and during the on stage, the UE may monitor the PDCCH for paging messages.

An RIS may be associated with an on state or an off state. During the on state, RIS elements may reflect impinging signals. During the on state, RIS elements may dynamically reflect impinging signals to target directions. During the off state, RIS elements cannot reflect impinging signals. In some cases, during the off state, RIS elements may be set in a default state, in which the RIS elements cannot control the direction of reflected signals. Rather, the RIS elements may function as a mirror or a scatterer. An RIS controller may be associated with an on state or an off state. During the on state, the RIS controller may monitor downlink channels (e.g., similar to when a C-DRX mode or I-DRX mode is on). During the on state, the RIS controller may actively transmit signals (e.g., similar to when a discontinuous transmission (DTX) mode is on). During the off state, the RIS controller cannot monitor downlink channels (e.g., similar to when a C-DRX mode or I-DRX mode is off). During the off state, the RIS controller cannot actively transmit signals (e.g., similar to when a DTX mode is off).

An RIS controller may be connected to an RIS having multiple panels or multiple sub-panels. However, the RIS controller may not be configured to control or configure the multiple panels or multiple sub-panels and to control or configure the RIS controller's on-off behavior. The RIS controller may not be aware of a relationship between an on-off state of the RIS controller and an on-off state of the RIS. In other words, the RIS controller on-off behavior may not depend on the on-off states of the panels and/or the sub-panels, which may degrade a performance of the RIS controller and/or the RIS.

In various aspects of techniques and apparatuses described herein, a device (e.g., a UE or a network node) may transmit, to an RIS controller, a configuration that indicates one or multiple on-off patterns. The one or multiple on-off patterns may be associated with one or more panels of an RIS associated with the RIS controller, one or more sub-panels of the RIS, and/or the RIS controller. An on-off pattern for a panel may define time periods associated with an on state of the panel and time periods associated with an off state of the panel. An on-off pattern for a sub-panel may define time periods associated with an on state of the sub-panel and time periods associated with an off state of the sub-panel. An on-off pattern for the RIS controller may define time periods associated with an on state of the RIS controller and time periods associated with an off state of the RIS controller. The RIS controller may configure the RIS based at least in part on the configuration received from the device. The RIS may apply the one or multiple on-off patterns in an individual manner to panels and/or sub-panels (e.g., all panels and/or sub-panels), and the RIS controller may apply an on-off pattern to itself. As a result, when the RIS controller is connected to the panels and/or the sub-panels, the RIS controller may be able to control and configure the panels and/or sub-panels, as well as control and configure the RIS controller's on-off behavior. The RIS controller's on-off behavior may relate to on-off states of the panels and/or sub-panels, which may improve a performance of the RIS controller and/or the RIS. By relating the RIS controller's on-off behavior and the on-off states of the panels and/or sub-panels, the RIS controller may be able to sleep for longer periods of time, which may improve a power consumption of the RIS controller.

In some aspects, the RIS controller may be configured with information regarding a relationship between an on-off state of the RIS controller and an on-off state of the RIS. The RIS controller may be configured with the information by another node, such as the device. In some aspects, the RIS controller may determine by itself the relationship between the on-off state of the RIS controller and the on-off state of the RIS. The RIS controller may perform the determination based at least in part on information received from the device. In some aspects, the relationship between the on-off state of the RIS controller and the on-off state of the RIS may be predefined in the RIS controller.

FIG. 6 is a diagram illustrating an example 600 associated with on-off patterns for panels and controllers associated with RISs, in accordance with the present disclosure. As shown in FIG. 6, example 600 includes communication between a device (e.g., UE 120 or network node 110), an RIS controller (e.g., RIS controller 122), and an RIS (e.g., RIS 124). In some aspects, the device, the RIS controller, and the RIS may be included in a wireless network, such as wireless network 100.

As shown by reference number 602, the device (e.g., a UE or a network node) may transmit, to the RIS controller, a configuration that indicates one or multiple on-off patterns. The device may transmit the configuration using RRC signaling. The device may transmit the configuration using a broadcast. The one or multiple on-off patterns may be associated with one or more panels of the RIS, one or more sub-panels of the RIS, and/or the RIS controller. An on-off pattern, of the one or multiple on-off patterns, may define time periods associated with an on state and time periods associated with an off state, with respect to the one or more panels, the one or more sub-panels, and/or the RIS controller. The one or multiple on-off patterns may be individually applied to the one or more panels, the one or more sub-panels, and/or the RIS controller.

In some aspects, the one or multiple on-off patterns may be applied to multiple panels individually. For example, a first on-off pattern may be applied to a first panel, and a second on-off pattern may be applied to a second panel. Additionally, or alternatively, an on-off pattern may be applied to multiple panels. For example, the first on-off pattern may be applied to the first panel and the second panel, and the second on-off pattern may be applied to a third panel. In some cases, the same on-off pattern may be applied to a plurality of panels (e.g., all panels).

In some aspects, an on-off pattern, of the one or multiple on-off patterns, may be associated with an RIS controller DRX on-off pattern, an RIS controller DTX on-off pattern, an RIS panel power on-off pattern, or an RIS panel reflection on-off pattern. The RIS controller DRX on-off pattern may be one of an RIS controller C-DRX on-off pattern or an RIS controller I-DRX on-off pattern. In some aspects, an on-off pattern, of the one or multiple on-off patterns, may be associated with different reflection directions or different beams. The different reflection directions or the different beams may be configured during on states of the one or more panels or the one or more sub-panels. In some aspects, an on-off pattern of the RIS controller may be associated with a same DRX pattern as an on-off pattern of the one or more panels. In some aspects, an on-off pattern, of the one or multiple on-off patterns, may indicate that the one or more panels are on during a time in which a UE served by the RIS is scheduled to perform a transmission. The transmission may be a downlink transmission, an uplink transmission, or a sidelink transmission.

In some aspects, the device may transmit, to the RIS controller, a query regarding a quantity of panels or a quantity of sub-panels that are connected to the RIS controller. The device may receive, from the RIS controller, a response based at least in part on the query. The configuration that indicates the one or multiple on-off patterns may be based at least in part on the response.

In some aspects, the device may transmit the configuration that indicates the one or multiple on-off patterns based at least in part on a dynamic signaling or a semi-static signaling. The one or multiple on-off patterns may include independent on-off patterns for the one or more panels and the RIS controller, where an on-off pattern for the one or more panels may be different from an on-off pattern for the RIS controller.

The one or multiple on-off patterns may include dependent on-off patterns for the one or more panels and the RIS controller, where an on-off pattern for the one or more panels may be dependent on an on-off pattern for the RIS controller, or the on-off pattern for the RIS controller may be dependent on the on-off pattern for the one or more panels.

In some aspects, an on-off pattern of the RIS controller may be based at least in part on the one or more panels and on states associated with the one or more panels, where an on state associated with the on-off pattern of the RIS controller may be aligned in a time domain with an on state associated with the one or more panels. In some aspects, an on-off pattern of the RIS controller may be based at least in part on the one or more panels and on-off states associated with the one or more panels, where an on state associated with the on-off pattern of the RIS controller may not be aligned in a time domain to an on-off state associated with the one or more panels. In some aspects, an on-off pattern of the one or more panels may be based at least in part on the RIS controller and on states associated with the RIS controller, where an on state associated with the on-off pattern of the one or more panels may be aligned in a time domain with an on state associated with the RIS controller.

As shown by reference number 604, the RIS controller may transmit, to the RIS, the configuration that indicates the one or multiple on-off patterns. The RIS controller may configure the RIS with the one or multiple on-off patterns based at least in part on the configuration that indicates the one or multiple on-off patterns. The RIS controller and/or the RIS may apply the one or multiple on-off patterns. For example, the RIS controller may apply the one or multiple on-off patterns, and/or the RIS may apply the one or multiple on-off patterns to panels and/or sub-panels associated with the RIS.

As shown by reference number 606, the device may receive, from the RIS controller, an indication based at least in part on a receipt of the configuration that indicates the one or multiple on-off patterns. The indication may indicate that the RIS controller successfully received the configuration or that the RIS controller did not successfully receive the configuration. In other words, the indication may be an acknowledgement or a negative acknowledgement. The indication may be a physical layer signal or a higher layer response. In some cases, when the device does not receive the indication within a certain period of time, the device may retransmit the configuration.

As indicated above, FIG. 6 is provided as an example. Other examples may differ from what is described with regard to FIG. 6.

In some aspects, an RIS may be controlled by a device. The device may be a UE or a network node. The device (or multiple devices) may configure one or more on-off patterns to the RIS. The device may transmit, to the RIS and/or an RIS controller, a configuration of the one or multiple on-off patterns. The one or more on-off patterns may be applied to panels (or panel groups), sub-panels (or sub-panel groups), and/or the RIS controller individually. For example, one on-off pattern may be applied to one panel, one on-off pattern may be applied to multiple panels, or one on-off pattern may be applied to all panels. Based at least in part on the configuration received from the device, the RIS and/or the RIS controller may apply the one or more on-off patterns. An on-off pattern may define time periods associated with an on state and time periods associated with an off state, with respect to the panels, the sub-panels, and/or the RIS controller. The on-off pattern may define an RIS controller DRX on-off pattern, an RIS controller DTX on-off pattern, an RIS panel power on-off pattern, and/or an RIS panel reflection on-off pattern. The on-off pattern may define time periods during which the RIS controller is in a sleep mode or a normal mode in accordance with the RIS controller DRX on-off pattern. The RIS controller DRX on-off pattern may be associated with a C-DRX on-off pattern or an I-DRX on-off pattern. The on-off pattern may define time periods during which the RIS controller is able to perform DTXs, in accordance with the RIS controller DTX on-off pattern. The on-off pattern may define time periods during which the panels and/or the sub-panels are turned on versus turned off. The on-off pattern may define time periods during which the panels and/or the sub-panels are able to reflect signals.

Depending on the on-off pattern, particular panels and/or sub-panels may be turned on or off at a given time. Depending on the on-off pattern, the RIS controller may be turned on or off at a given time.

In some aspects, the device may query the RIS controller regarding a quantity of panels and/or sub-panels that are connected to the RIS controller. The device may determine, based at least in part on the query, the quantity of panels and/or sub-panels that are able to be controlled by the device. The device may determine, based at least in part on the query, the quantity of panels and/or sub-panels that have not been previously configured and/or the quantity of panels and/or sub-panels not controlled by other devices. The RIS controller may report, based at least in part on the query or irrespective of the query, the quantity of panels and/or sub-panels that are able to be controlled by the device.

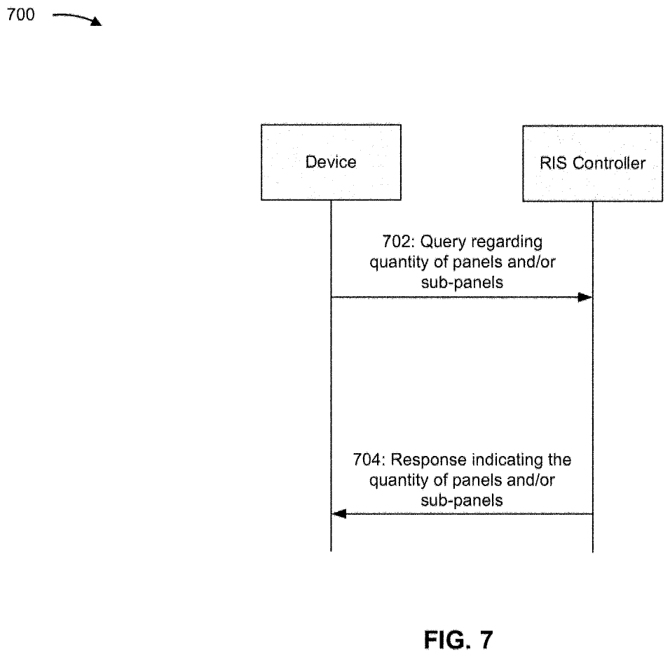

FIG. 7 is a diagram illustrating an example 700 associated with on-off patterns for panels and controllers associated with RISs, in accordance with the present disclosure. As shown in FIG. 7, example 700 includes communication between a device (e.g., UE 120 or network node 110) and an RIS controller (e.g., RIS controller 122). In some aspects, the device and the RIS controller may be included in a wireless network, such as wireless network 100.

As shown by reference number 702, the device may transmit, to the RIS controller, a query regarding a quantity of panels and/or sub-panels that are not being controlled or used by the device. As shown by reference number 704, the RIS controller may transmit a response, based at least in part on the query, indicating the quantity of panels and/or sub-panels (e.g., three panels) that are not currently being controlled or used.

As indicated above, FIG. 7 is provided as an example. Other examples may differ from what is described with regard to FIG. 7.

In some aspects, RRC signaling may be used for signaling an on-off pattern configuration, a device query regarding a quantity of panels and/or sub-panels, and/or an RIS controller response. The RRC signaling may not preclude a new layer 1 (L1) or layer 2 (L2) signaling. In some aspects, different configurations may be associated with different panels or sub-panels via an explicit indication or an implicit indication. For example, the explicit indication may indicate a first on-off pattern for a first panel, a second on-off pattern for a second panel, a third on-off pattern for a third panel, and so on. The implicit indication may indicate the first on-off pattern, the second on-off pattern, the third on-off pattern, and so on, which may not exactly indicate the specific panel. Either the explicit indication or the implicit indication may be employed. In some cases, one panel may be associated with multiple configurations.

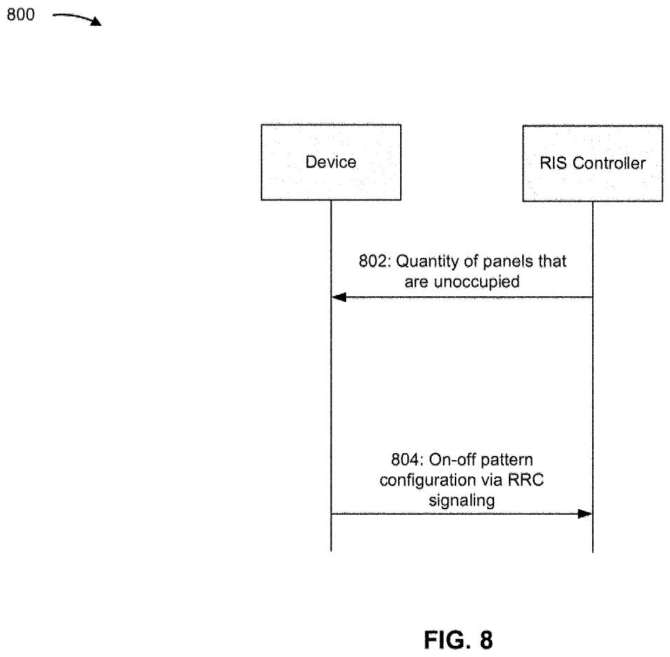

FIG. 8 is a diagram illustrating an example 800 associated with on-off patterns for panels and controllers associated with RISs, in accordance with the present disclosure. As shown in FIG. 8, example 800 includes communication between a device (e.g., UE 120 or network node 110) and an RIS controller (e.g., RIS controller 122). In some aspects, the device and the RIS controller may be included in a wireless network, such as wireless network 100.

As shown by reference number 802, the RIS controller may transmit, to the device, an indication of a quantity of panels that are unoccupied. The panels may not be associated with an on-off pattern. As shown by reference number 804, the device may transmit, to the RIS controller, a response indicating an on-off pattern configuration for the quantity of panels. The device may transmit the response via an RRC signaling.

For example, the on-off pattern configuration may indicate a first on-off pattern for a first panel, a second on-off pattern for a second panel, and a third on-off pattern for a third panel.

As indicated above, FIG. 8 is provided as an example. Other examples may differ from what is described with regard to FIG. 8.

In some aspects, sub-panels may be configured with on-off patterns, but reflection directions may not be known for the RIS sub-panels. In this case, different reflection directions (e.g., different configurations or different beams) may be configured to different panels and/or sub-panels during an on state, where the different reflection directions may be associated with different on-off patterns. For example, a first on-off pattern may be associated with a first panel and a first beam, a second on-off pattern may be associated with a second panel and a second beam, and a third on-off pattern may be associated with a third panel and a third beam. The beams may be relatively wide beams, to provide increased coverage. The beams may be rewritten or modified by the device. The device may rewrite the beams in a semi-static manner (e.g., the device may configure a second panel associated with an on state to a third beam). The device may rewrite the beams in a dynamic manner (e.g., the device may configure a third beam and a fourth beam in a second panel associated with an on state).

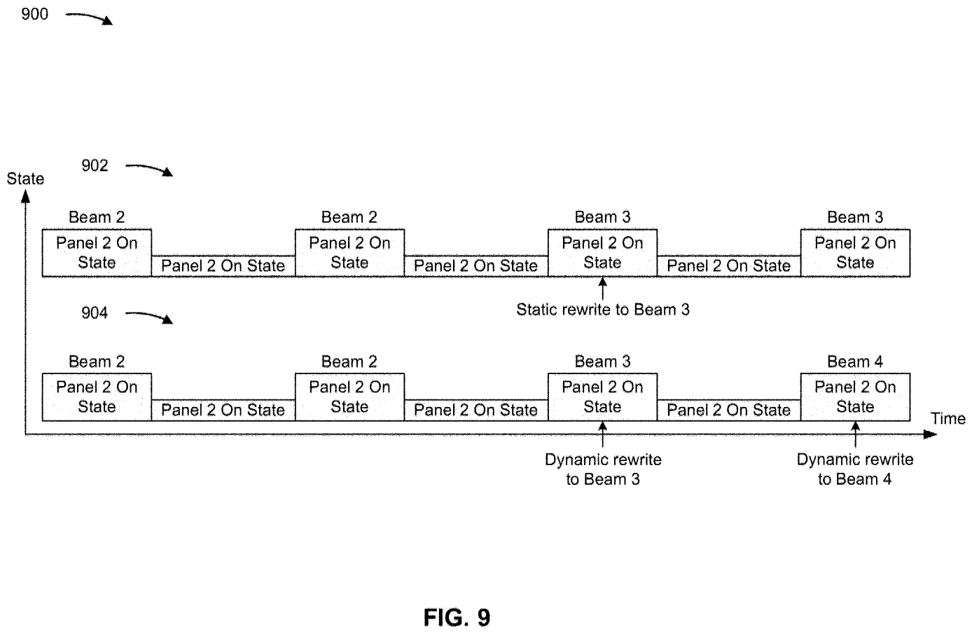

FIG. 9 is a diagram illustrating an example 900 associated with on-off patterns for panels and controllers associated with RISs, in accordance with the present disclosure.

In some aspects, an on-off pattern configuration may be defined for a panel. The on-off pattern configuration may define an on-off pattern for the panel. The on-off pattern configuration may define time periods during which the panel is associated with an on state and time periods during which the panel is associated with an off state.

As shown by reference number 902, an on-off pattern configuration may be defined for a second panel. The on-off pattern configuration may define time periods during which the second panel is associated with an on state and time periods during which the second panel is associated with an off state. Initially, the second panel, when in the on state, may be associated with a second beam. The second panel, when in the on state, may be switched to being associated with a third beam based at least in part on a static rewrite to the third beam.

As shown by reference number 904, an on-off pattern configuration may be defined for a second panel. The on-off pattern configuration may define time periods during which the second panel is associated with an on state and time periods during which the second panel is associated with an off state. Initially, the second panel, when in the on state, may be associated with a second beam. The second panel, when in the on state, may be switched to being associated with a third beam based at least in part on a dynamic rewrite to the third beam. At a later time, the second panel, when in the on state, may be switched to being associated with a fourth beam based at least in part on a dynamic rewrite to the fourth beam.

As indicated above, FIG. 9 is provided as an example. Other examples may differ from what is described with regard to FIG. 9.

In some aspects, a device may dynamically or semi-statically reconfigure panels and/or sub-panels of an RIS. In order to receive such configurations, an RIS controller may need to be in an on state (e.g., the RIS controller may need to be awake). However, when the RIS controller is always on, the RIS controller may unnecessarily consume an inordinate amount of power, so the RIS controller may be in a DRX mode to save power.

In some aspects, independent or separate on-off patterns may be configured for the RIS controller and the panel. For example, one on-off pattern may be configured for the RIS controller, and another on-off pattern may be configured for the panel. The device may configure separate on-off patterns for the RIS controller and the panels. The separate on-off patterns may be associated with different periods and/or offsets.

In some aspects, dependent on-off patterns may be configured between the RIS controller and the panel. The device may only configure an on-off pattern for the panel, and the RIS controller may determine an on-off pattern by itself. The RIS controller may determine its on-off pattern based at least in part on the on-off pattern configured for the panel. The device may also configure an on-off pattern for the RIS controller, and the RIS may determine an on-off pattern for the panel by itself (e.g., without an instruction from the device). The RIS may determine the on-off pattern for the panel based at least in part on the on-off pattern configured for the RIS controller. The device may configure an RIS on-off pattern, without further indication, and the RIS may determine an on-off pattern of the panel and/or an on-off pattern of the RIS controller by itself, which may be based at least in part on the RIS on-off pattern configured by the device.

In some aspects, the RIS controller may share the same DRX pattern as an on-off pattern of panels, without a need for extra signaling from the device to indicate the RIS controller's DRX behavior. When sharing the same DRX pattern, the RIS controller may follow an on-off pattern that corresponds to a union set of one or multiple on-off patterns for multiple panels.

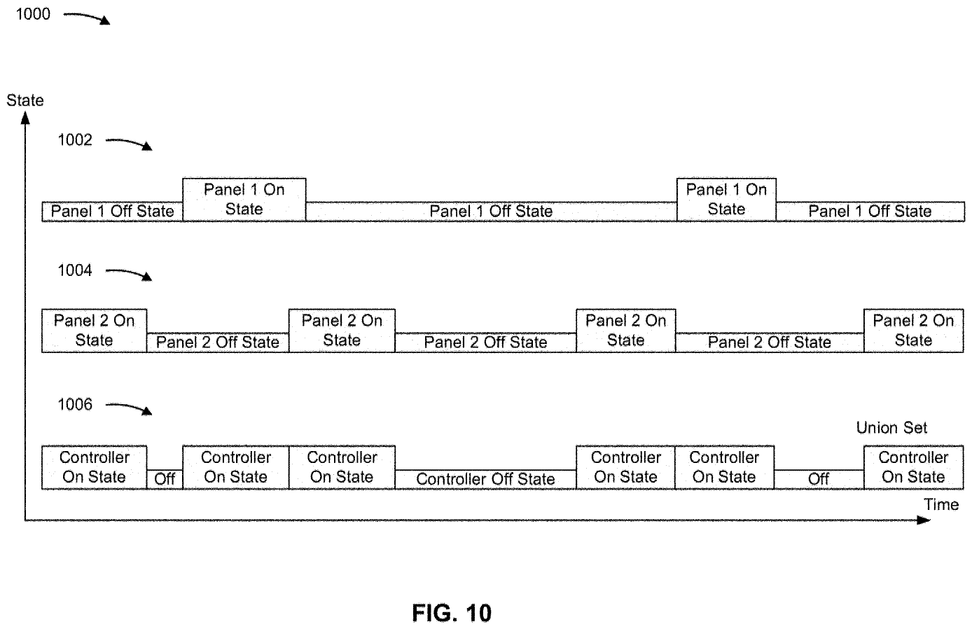

FIG. 10 is a diagram illustrating an example 1000 associated with on-off patterns for panels and controllers associated with RISs, in accordance with the present disclosure.

As shown by reference number 1002, an on-off pattern may be defined for a first panel. The on-off pattern may define time periods during which the first panel is associated with an on state and time periods during which the first panel is associated with an off state.

As shown by reference number 1004, an on-off pattern may be defined for a second panel. The on-off pattern may define time periods during which the second panel is associated with an on state and time periods during which the second panel is associated with an off state. The on-off pattern for the second panel may be different than the on-off pattern for the first panel.

As shown by reference number 1006, an on-off pattern may be defined for an RIS controller, where the on-off pattern for the RIS controller may be based at least in part on the on-off pattern for the first panel and the on-off pattern for the second panel. The on-off pattern for the RIS controller may be based at least in part on a union set of the on-off pattern for the first panel and the on-off pattern for the second panel. The union set may refer to the union of the on states (e.g., when either the first panel or the second panel is on, the RIS controller is on). In some cases, the RIS controller may share the same DRX pattern as compared to the on-off patterns of the first panel and the second panel.

As indicated above, FIG. 10 is provided as an example. Other examples may differ from what is described with regard to FIG. 10.

In some aspects, every on-state of a panel, across a plurality of panels (e.g., a first panel and a second panel), may correspond to an on-state of an RIS controller. The on-state of the panel and the on-state of the RIS controller may be associated with the same time duration. The on-state of the panel may be aligned with the on-state of the RIS controller in the time domain. Every K on-states for a panel may correspond to an on-state of the one RIS, for the same on-duration, and may be aligned in the time domain. In this case, K may be dynamically configured or preconfigured, and K may be different for different panels (occupied by different devices). Similarly, every K on-states for the RIS controller may correspond to an on-state of one panel.

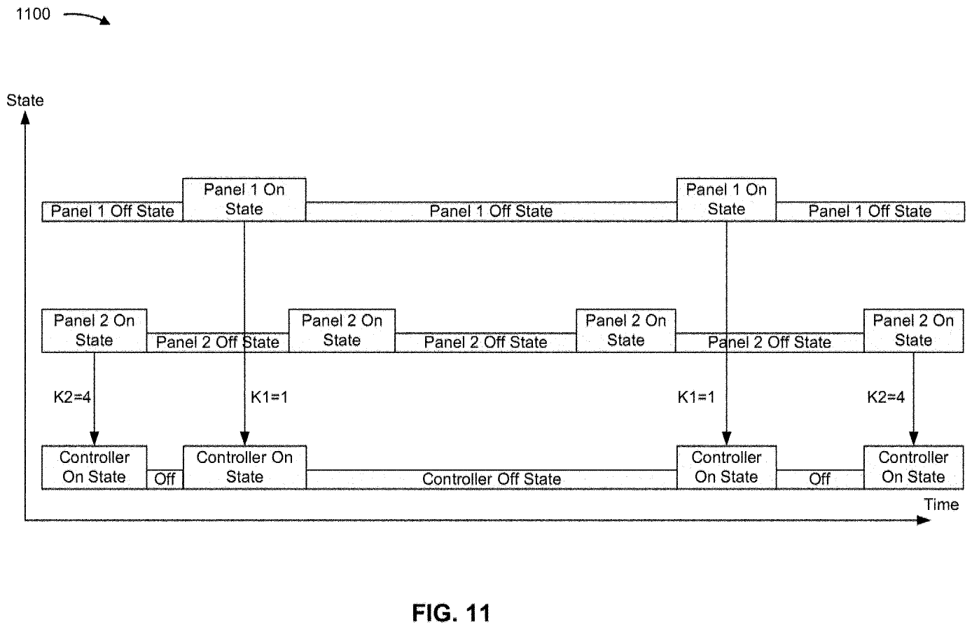

FIG. 11 is a diagram illustrating an example 1100 associated with on-off patterns for panels and controllers associated with RISs, in accordance with the present disclosure.

As shown in FIG. 11, an on-state associated with a second panel may correspond in a time domain to an on-state associated with an RIS controller (K2=4).

An on-state associated with a first panel may correspond in a time domain to an on-state associated with the RIS controller (K1=1). Every on state of the first panel may be associated with an on state of the RIS controller, but only every fourth on state of the second panel may be associated with an on state of the RIS controller.

As indicated above, FIG. 11 is provided as an example. Other examples may differ from what is described with regard to FIG. 11.

In some aspects, for an on-state of a panel and an on-state of an RIS controller, the on-states may be associated with different durations and may not be aligned in a time domain. A first quantity (X) of slots before an on-state of a panel, a width (Y) (in quantity of slots) associated with the on-state of the RIS controller, a quantity (Z) of slots before an off-state of a panel, and a second quantity(S) of slots or symbols before an on-state of a panel may be preconfigured. In some cases, values for X, Y, Z, and/or S may be configured in a dynamic manner, and values for X, Y, Z, and/or S may be associated with an upper bound, a lower bound, and/or an exact value.

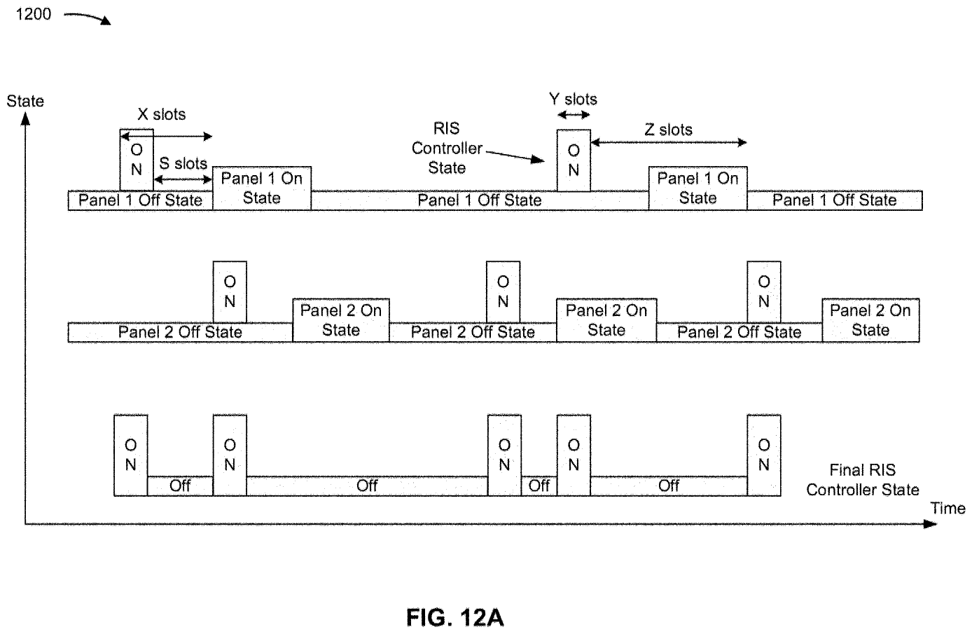

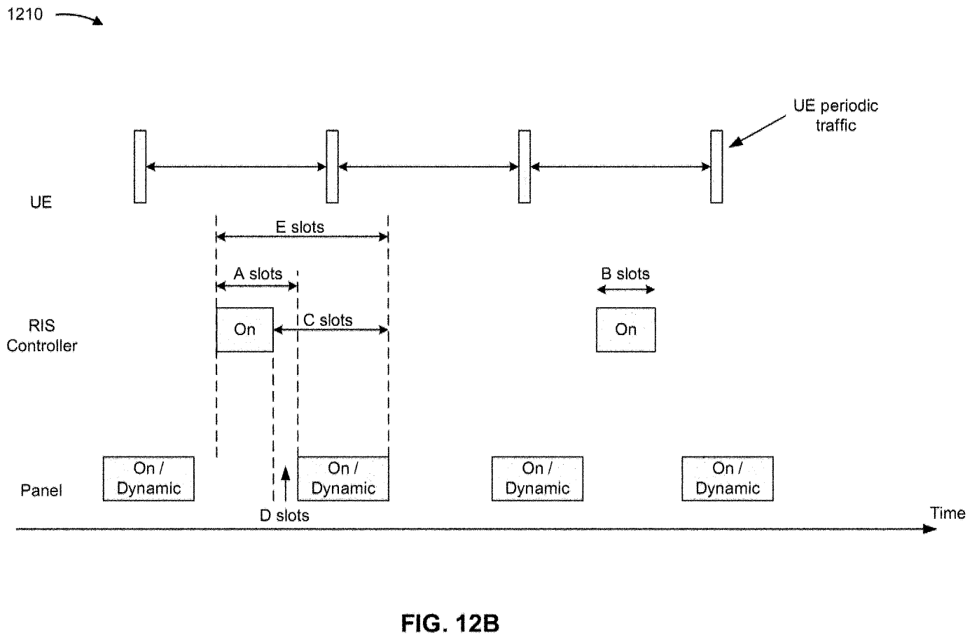

FIGS. 12A and 12B are diagrams illustrating examples 1200, 1210 associated with on-off patterns for panels and controllers associated with RISs, in accordance with the present disclosure.

As shown in FIG. 12A, a quantity of slots/symbols (X) before an on-state of a panel (e.g., a first panel) may be defined. A width (Y slots/symbols) associated with an on-state of an RIS controller may be defined. A quantity of slots/symbols (Z) before an off-state of a panel (e.g., the first panel) may be defined. A quantity of slots/symbols (S) before the on-state of the panel may be defined. Values for X, Y, Z, and/or S may be configured in a dynamic manner, and values for X, Y, Z, and/or S may be associated with an upper bound, a lower bound, and/or an exact value. On-states and off-states may be defined for the RIS controller, where the on-states and the off-states may not necessarily correspond in a time domain to on-states and off-states of the first panel and a second panel, respectively.

As shown in FIG. 12B, a UE may be associated with periodic traffic. A relationship between an on-state (e.g., a DRX on-state) of an RIS controller and an on-state (e.g., a dynamic on-state) of a panel may be configured or preconfigured. During the on-state of the panel, the panel may be turned on and able to reflect signals. A quantity (A) of slots/symbols between a start of the on-state of the RIS controller and a start of the on-state of the panel, a width (B) (in quantity of slots/symbols) associated with the on-state of the RIS controller, a quantity (C) of slots/symbols between an end of the on-state of the RIS controller and an end of the on-state of the panel, a quantity (D) of slots/symbols between the end of the on-state of the RIS controller and a start of the on-state of the panel, and a quantity (E) of slots/symbols between the start of the on-state of the RIS controller and the end of the on-state of the panel may be configured or preconfigured. A periodic ratio may be configured between a quantity of on-states of the RIS controller and a quantity of on-states of the panel. The periodic ratio may be preconfigured or dynamically configured to the UE.

As an example, a UE traffic period may be one packet per second. The UE may configure a pattern associated with the one packet per second to a panel and/or an RIS controller. The panel and/or the RIS controller may transmit a response to the UE, where the response may indicate that the pattern was successfully received. The panel may be in an on-state when the UE transmits a packet, which may be based at least in part on a relationship between the panel and the RIS controller being indicated to the UE. The UE may be able to reconfigure the panel and/or the RIS controller one time every certain quantity of packets (e.g., every two packets). A time window associated with an on-state of the RIS controller may be five slots. Further, when considering an RIS configuration response time, a certain gap (e.g., two slots) may be configured between an end of an on-state of the RIS controller and a start of the on-state of the panel.

As indicated above, FIGS. 12A and 12B are provided as examples. Other examples may differ from what is described with regard to FIGS. 12A and 12B.

In some aspects, other relationships between a DRX on state of an RIS controller and an on-state of a panel or sub-panel may be defined. The on-state or an off-state of the panel may be based at least in part on an on-state or an off-state of the RIS controller. A first quantity (X) of slots before the on-state of the RIS controller, a width (Y) (in quantity of slots) associated with the on-state of the RIS controller, a quantity (Z) of slots before the off-state of the RIS controller, and a second quantity(S) of slots before the on-state of the RIS controller may be preconfigured. In some cases, values for X, Y, Z, and/or S may be configured in a dynamic manner, and values for X, Y, Z, and/or S may be associated with an upper bound, a lower bound, and/or an exact value.

In some aspects, an on-off pattern for panels or sub-panels may be extended to an RIS-served-UE DRX on-off pattern. The on-off pattern for panels or sub-panels may be extended to UE scheduling/grant information, such as a UE semi-persistent scheduling (SPS) or a UE configured grant. The on-off pattern for panels or sub-panels may be extended to other periodic configured configurations, such as a channel state information reference signal (CSI-RS) or a sounding reference signal (SRS). Such periodic configured configurations may implicitly indicate that the panel should be on, when an RIS-served-UE is scheduled for a downlink or uplink transmission. Other periodic configured configurations may include a scheduling request (SR), which may indicate that the UE has information to transmit, and a buffer status report (BSR), which may indicate an amount of information the UE has to transmit. In some aspects, an on-off pattern for panels or sub-panels may be extended to broadcast information delivered to the RIS via a physical sidelink broadcast channel (PSBCH), which may be transmitted with a sidelink synchronization signal (SLSS). The RIS may be in an on-state and reflect the broadcast information in time slots associated with the broadcast information.

FIG. 13 is a diagram illustrating an example process 1300 performed, for example, by a device, in accordance with the present disclosure. Example process 1300 is an example where the device (e.g., UE 120 or network node 110) performs operations associated with on-off patterns for panels and controllers associated with RISs.

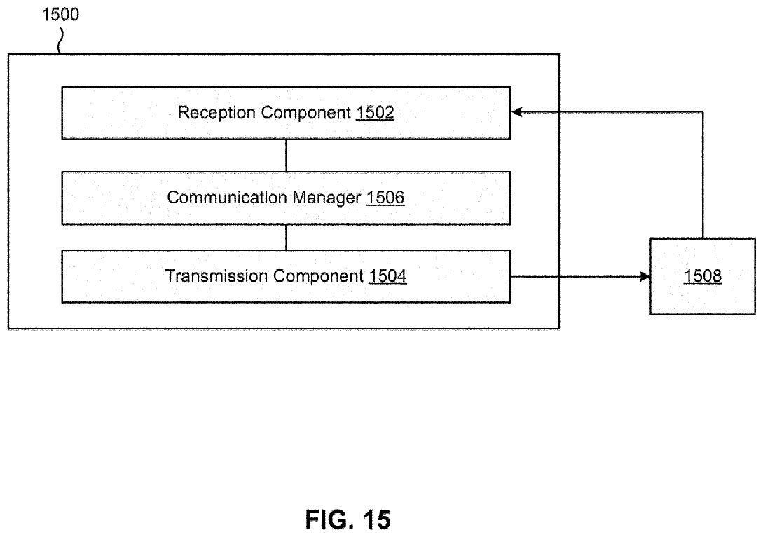

As shown in FIG. 13, in some aspects, process 1300 may include transmitting a configuration that indicates one or multiple on-off patterns, the one or multiple on-off patterns being associated with one or more of: one or more panels of an RIS, one or more sub-panels of the RIS, or an RIS controller (block 1310). For example, the device (e.g., using transmission component 1504 and/or communication manager 1506, depicted in FIG. 15) may transmit a configuration that indicates one or multiple on-off patterns, the one or multiple on-off patterns being associated with one or more of: one or more panels of an RIS, one or more sub-panels of the RIS, or an RIS controller, as described above, for example, with reference to FIGS. 6, 7, 8, 9, 10, 11, and/or 12A-12B.

As further shown in FIG. 13, in some aspects, process 1300 may include receiving an indication based at least in part on a receipt of the configuration that indicates the one or multiple on-off patterns (block 1320). For example, the device (e.g., using reception component 1502 and/or communication manager 1506, depicted in FIG. 15) may receive an indication based at least in part on a receipt of the configuration that indicates the one or multiple on-off patterns, as described above, for example, with reference to FIGS. 6, 7, 8, 9, 10, 11, and/or 12A-12B.

Process 1300 may include additional aspects, such as any single aspect or any combination of aspects described below and/or in connection with one or more other processes described elsewhere herein.

In a first aspect, an on-off pattern, of the one or multiple on-off patterns, defines one or more of time periods associated with an on state or time periods associated with an off state, with respect to the one or more panels, the one or more sub-panels, or the RIS controller.

In a second aspect, alone or in combination with the first aspect, the one or multiple on-off patterns are individually applied to one or more of the one or more panels, the one or more sub-panels, or the RIS controller.

In a third aspect, alone or in combination with one or more of the first and second aspects, an on-off pattern, of the one or multiple on-off patterns, is associated with one of an RIS controller DRX on-off pattern, an RIS controller DTX on-off pattern, an RIS panel power on-off pattern, or an RIS panel reflection on-off pattern, and the RIS controller DRX on-off pattern is one of an RIS controller C-DRX on-off pattern or an RIS controller I-DRX on-off pattern.

In a fourth aspect, alone or in combination with one or more of the first through third aspects, process 1300 includes transmitting a query regarding a quantity of panels or a quantity of sub-panels that are connected to the RIS controller, and receiving a response based at least in part on the query, wherein the configuration that indicates the one or multiple on-off patterns is based at least in part on the response.

In a fifth aspect, alone or in combination with one or more of the first through fourth aspects, an on-off pattern, of the one or multiple on-off patterns, is associated with different reflection directions or different beams, and the different reflection directions or the different beams are configured during on states of the one or more panels or the one or more sub-panels.

In a sixth aspect, alone or in combination with one or more of the first through fifth aspects, process 1300 includes transmitting the configuration that indicates the one or multiple on-off patterns based at least in part on a dynamic signaling or a semi-static signaling.

In a seventh aspect, alone or in combination with one or more of the first through sixth aspects, the one or multiple on-off patterns include independent on-off patterns for the one or more panels and the RIS controller, and an on-off pattern for the one or more panels is separate from an on-off pattern for the RIS controller.

In an eighth aspect, alone or in combination with one or more of the first through seventh aspects, the one or multiple on-off patterns include dependent on-off patterns for the one or more panels and the RIS controller, and an on-off pattern for the one or more panels is dependent on an on-off pattern for the RIS controller, or the on-off pattern for the RIS controller is dependent on the on-off pattern for the one or more panels.

In a ninth aspect, alone or in combination with one or more of the first through eighth aspects, an on-off pattern of the RIS controller is associated with a same DRX pattern as an on-off pattern of the one or more panels.

In a tenth aspect, alone or in combination with one or more of the first through ninth aspects, an on-off pattern of the RIS controller is based at least in part on the one or more panels and on states associated with the one or more panels, wherein an on state associated with the on-off pattern of the RIS controller is aligned in a time domain with an on state associated with the one or more panels.

In an eleventh aspect, alone or in combination with one or more of the first through tenth aspects, an on-off pattern of the RIS controller is based at least in part on the one or more panels and on-off states associated with the one or more panels, wherein an on state associated with the on-off pattern of the RIS controller is not aligned in a time domain to an on-off state associated with the one or more panels.

In a twelfth aspect, alone or in combination with one or more of the first through eleventh aspects, an on-off pattern of the one or more panels is based at least in part on the RIS controller and on states associated with the RIS controller, wherein an on state associated with the on-off pattern of the one or more panels is aligned in a time domain with an on state associated with the RIS controller.

In a thirteenth aspect, alone or in combination with one or more of the first through twelfth aspects, an on-off pattern, of the one or multiple on-off patterns, indicates that the one or more panels are on during a time in which a UE served by the RIS is scheduled to perform a downlink transmission or an uplink transmission.

In a fourteenth aspect, alone or in combination with one or more of the first through thirteenth aspects, process 1300 includes transmitting the configuration that indicates the one or multiple on-off patterns based at least in part on a broadcast.

In a fifteenth aspect, alone or in combination with one or more of the first through fourteenth aspects, the device is a UE or a network node.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by an RIS controller, in accordance with the present disclosure. Example process 1400 is an example where the RIS controller (e.g., RIS controller 122) performs operations associated with on-off patterns for panels and controllers associated with RISs.

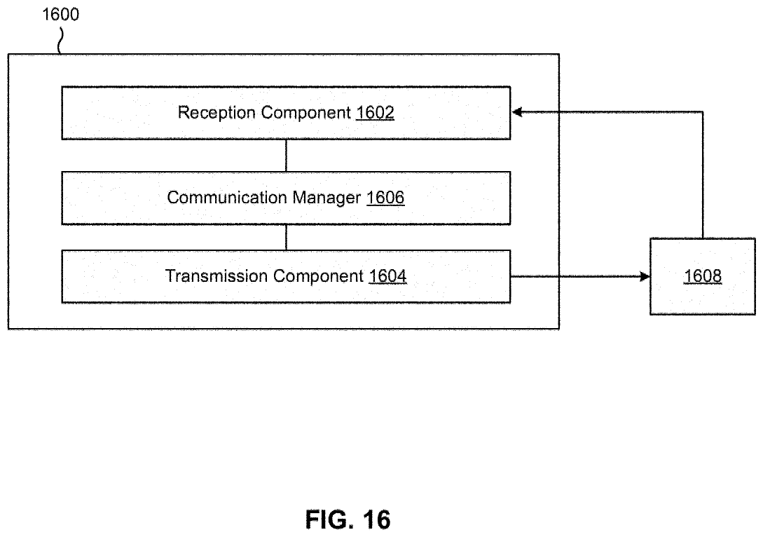

As shown in FIG. 14, in some aspects, process 1400 may include receiving a configuration that indicates one or multiple on-off patterns, the one or multiple on-off patterns being associated with one or more of: one or more panels of an RIS associated with the RIS controller, one or more sub-panels of the RIS, or the RIS controller (block 1410). For example, the RIS (e.g., using reception component 1602 and/or communication manager 1606, depicted in FIG. 16) may receive a configuration that indicates one or multiple on-off patterns, the one or multiple on-off patterns being associated with one or more of: one or more panels of an RIS associated with the RIS controller, one or more sub-panels of the RIS, or the RIS controller, as described above, for example, with reference to FIGS. 6, 7, 8, 9, 10, 11, and/or 12A-12B.

As further shown in FIG. 14, in some aspects, process 1400 may include configuring the RIS with the one or multiple on-off patterns based at least in part on the configuration that indicates the one or multiple on-off patterns (block 1420). For example, the RIS (e.g., using transmission component 1604 and/or communication manager 1606, depicted in FIG. 16) may configure the RIS with the one or multiple on-off patterns based at least in part on the configuration that indicates the one or multiple on-off patterns, as described above, for example, with reference to FIGS. 6, 7, 8, 9, 10, 11, and/or 12A-12B.

Process 1400 may include additional aspects, such as any single aspect or any combination of aspects described below and/or in connection with one or more other processes described elsewhere herein.

In a first aspect, an on-off pattern, of the one or multiple on-off patterns, defines one or more of time periods associated with an on state or time periods associated with an off state, with respect to the one or more panels, the one or more sub-panels, or the RIS controller.

In a second aspect, alone or in combination with the first aspect, the one or multiple on-off patterns are individually applied to one or more of the one or more panels, the one or more sub-panels, or the RIS controller.

In a third aspect, alone or in combination with one or more of the first and second aspects, an on-off pattern, of the one or multiple on-off patterns, is associated with one of an RIS controller DRX on-off pattern, an RIS controller DTX on-off pattern, an RIS panel power on-off pattern, or an RIS panel reflection on-off pattern, and the RIS controller DRX on-off pattern is one of an RIS controller C-DRX on-off pattern or an RIS controller I-DRX on-off pattern.

In a fourth aspect, alone or in combination with one or more of the first through third aspects, process 1400 includes receiving a query regarding a quantity of panels or a quantity of sub-panels that are connected to the RIS controller, and transmitting a response based at least in part on the query, wherein the configuration that indicates the one or multiple on-off patterns is based at least in part on the response.

In a fifth aspect, alone or in combination with one or more of the first through fourth aspects, an on-off pattern, of the one or multiple on-off patterns, is associated with different reflection directions or different beams, and the different reflection directions or the different beams are configured during on states of the one or more panels or the one or more sub-panels.

In a sixth aspect, alone or in combination with one or more of the first through fifth aspects, process 1400 includes receiving the configuration that indicates the one or multiple on-off patterns based at least in part on a dynamic signaling or a semi-static signaling.

In a seventh aspect, alone or in combination with one or more of the first through sixth aspects, the one or multiple on-off patterns include independent on-off patterns for the one or more panels and the RIS controller, and an on-off pattern for the one or more panels is separate from an on-off pattern for the RIS controller.

In an eighth aspect, alone or in combination with one or more of the first through seventh aspects, the one or multiple on-off patterns include dependent on-off patterns for the one or more panels and the RIS controller, and an on-off pattern for the one or more panels is dependent on an on-off pattern for the RIS controller, or the on-off pattern for the RIS controller is dependent on the on-off pattern for the one or more panels.

In a ninth aspect, alone or in combination with one or more of the first through eighth aspects, an on-off pattern of the RIS controller is associated with a same DRX pattern as an on-off pattern of the one or more panels.

In a tenth aspect, alone or in combination with one or more of the first through ninth aspects, an on-off pattern of the RIS controller is based at least in part on the one or more panels and on states associated with the one or more panels, wherein an on state associated with the on-off pattern of the RIS controller is aligned in a time domain with an on state associated with the one or more panels.

In an eleventh aspect, alone or in combination with one or more of the first through tenth aspects, an on-off pattern of the RIS controller is based at least in part on the one or more panels and on-off states associated with the one or more panels, wherein an on state associated with the on-off pattern of the RIS controller is not aligned in a time domain to an on-off state associated with the one or more panels.

In a twelfth aspect, alone or in combination with one or more of the first through eleventh aspects, an on-off pattern of the one or more panels is based at least in part on the RIS controller and on states associated with the RIS controller, wherein an on state associated with the on-off pattern of the one or more panels is aligned in a time domain with an on state associated with the RIS controller.

In a thirteenth aspect, alone or in combination with one or more of the first through twelfth aspects, an on-off pattern, of the one or multiple on-off patterns, indicates that the one or more panels are on during a time in which a UE served by the RIS is scheduled to perform a downlink transmission or an uplink transmission.

In a fourteenth aspect, alone or in combination with one or more of the first through thirteenth aspects, process 1400 includes receiving the configuration that indicates the one or multiple on-off patterns based at least in part on a broadcast.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a device, or a device may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 or the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 6-11, 12A, and 12B. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the device described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the device described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the device described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a configuration that indicates one or multiple on-off patterns, the one or multiple on-off patterns being associated with one or more of: one or more panels of an RIS, one or more sub-panels of the RIS, or an RIS controller. The reception component 1502 may receive an indication based at least in part on a receipt of the configuration that indicates the one or multiple on-off patterns. The transmission component 1504 may transmit a query regarding a quantity of panels or a quantity of sub-panels that are connected to the RIS controller. The reception component 1502 may receive a response based at least in part on the query, wherein the configuration that indicates the one or multiple on-off patterns is based at least in part on the response.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be an RIS controller, or an RIS controller may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 160 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 6-11, 12A, and 12B. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the RIS controller described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the RIS controller described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the RIS controller described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive a configuration that indicates one or multiple on-off patterns, the one or multiple on-off patterns being associated with one or more of: one or more panels of an RIS, one or more sub-panels of the RIS, or an RIS controller. The transmission component 1604 may transmit an indication based at least in part on a receipt of the configuration that indicates the one or multiple on-off patterns. The reception component 1602 may receive a query regarding a quantity of panels or a quantity of sub-panels that are connected to the RIS controller. The transmission component 1604 may transmit a response based at least in part on the query, wherein the configuration that indicates the one or multiple on-off patterns is based at least in part on the response.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a device, comprising: transmitting a configuration that indicates one or multiple on-off patterns, the one or multiple on-off patterns being associated with one or more of: one or more panels of a reconfigurable intelligent surface (RIS), one or more sub-panels of the RIS, or an RIS controller; and receiving an indication based at least in part on a receipt of the configuration that indicates the one or multiple on-off patterns.

Aspect 2: The method of Aspect 1, wherein an on-off pattern, of the one or multiple on-off patterns, defines one or more of time periods associated with an on state or time periods associated with an off state, with respect to the one or more panels, the one or more sub-panels, or the RIS controller.

Aspect 3: The method of any of Aspects 1-2, wherein the one or multiple on-off patterns are individually applied to one or more of: the one or more panels, the one or more sub-panels, or the RIS controller.

Aspect 4: The method of any of Aspects 1-3, wherein an on-off pattern, of the one or multiple on-off patterns, is associated with one of: an RIS controller discontinuous reception (DRX) on-off pattern, an RIS controller discontinuous transmission (DTX) on-off pattern, an RIS panel power on-off pattern, or an RIS panel reflection on-off pattern, and wherein the RIS controller DRX on-off pattern is one of an RIS controller connected mode DRX (C-DRX) on-off pattern or an RIS controller idle mode DRX (I-DRX) on-off pattern.

Aspect 5: The method of any of Aspects 1-4, further comprising: transmitting a query regarding a quantity of panels or a quantity of sub-panels that are connected to the RIS controller; and receiving a response based at least in part on the query, wherein the configuration that indicates the one or multiple on-off patterns is based at least in part on the response.

Aspect 6: The method of any of Aspects 1-5, wherein an on-off pattern, of the one or multiple on-off patterns, is associated with different reflection directions or different beams, and wherein the different reflection directions or the different beams are configured during on states of the one or more panels or the one or more sub-panels.

Aspect 7: The method of any of Aspects 1-6, wherein transmitting the configuration that indicates the one or multiple on-off patterns is based at least in part on a dynamic signaling or a semi-static signaling.

Aspect 8: The method of any of Aspects 1-7, wherein the one or multiple on-off patterns includes independent on-off patterns for the one or more panels and the RIS controller, and wherein an on-off pattern for the one or more panels is separate from an on-off pattern for the RIS controller.

Aspect 9: The method of any of Aspects 1-8, wherein the one or multiple on-off patterns includes dependent on-off patterns for the one or more panels and the RIS controller, and wherein an on-off pattern for the one or more panels is dependent on an on-off pattern for the RIS controller, or the on-off pattern for the RIS controller is dependent on the on-off pattern for the one or more panels.

Aspect 10: The method of any of Aspects 1-9, wherein an on-off pattern of the RIS controller is associated with a same discontinuous reception (DRX) pattern as an on-off pattern of the one or more panels.

Aspect 11: The method of any of Aspects 1-10, wherein an on-off pattern of the RIS controller is based at least in part on the one or more panels and on states associated with the one or more panels, wherein an on state associated with the on-off pattern of the RIS controller is aligned in a time domain with an on state associated with the one or more panels.

Aspect 12: The method of any of Aspects 1-11, wherein an on-off pattern of the RIS controller is based at least in part on the one or more panels and on-off states associated with the one or more panels, wherein an on state associated with the on-off pattern of the RIS controller is not aligned in a time domain to an on-off state associated with the one or more panels.

Aspect 13: The method of any of Aspects 1-12, wherein an on-off pattern of the one or more panels is based at least in part on the RIS controller and on states associated with the RIS controller, wherein an on state associated with the on-off pattern of the one or more panels is aligned in a time domain with an on state associated with the RIS controller.

Aspect 14: The method of any of Aspects 1-13, wherein an on-off pattern, of the one or multiple on-off patterns, indicates that the one or more panels are on during a time in which a user equipment (UE) served by the RIS is scheduled to perform a downlink transmission or an uplink transmission.

Aspect 15: The method of any of Aspects 1-14, wherein transmitting the configuration that indicates the one or multiple on-off patterns is based at least in part on a broadcast.

Aspect 16: The method of any of Aspects 1-15, wherein the device is a user equipment (UE) or a network node.

Aspect 17: A method of wireless communication performed by a reconfigurable intelligent surface (RIS) controller, comprising: receiving a configuration that indicates one or multiple on-off patterns, the one or multiple on-off patterns being associated with one or more of: one or more panels of an RIS associated with the RIS controller, one or more sub-panels of the RIS, or the RIS controller; and configuring the RIS with the one or multiple on-off patterns based at least in part on the configuration that indicates the one or multiple on-off patterns.

Aspect 18: The method of Aspect 17, wherein an on-off pattern, of the one or multiple on-off patterns, defines one or more of time periods associated with an on state or time periods associated with an off state, with respect to the one or more panels, the one or more sub-panels, or the RIS controller.

Aspect 19: The method of any of Aspects 17-18, wherein the one or multiple on-off patterns are individually applied to one or more of: the one or more panels, the one or more sub-panels, or the RIS controller.

Aspect 20: The method of any of Aspects 17-19, wherein an on-off pattern, of the one or multiple on-off patterns, is associated with one of: an RIS controller discontinuous reception (DRX) on-off pattern, an RIS controller discontinuous transmission (DTX) on-off pattern, an RIS panel power on-off pattern, or an RIS panel reflection on-off pattern, and wherein the RIS controller DRX on-off pattern is one of an RIS controller connected mode DRX (C-DRX) on-off pattern or an RIS controller idle mode DRX (I-DRX) on-off pattern.

Aspect 21: The method of any of Aspects 17-20, further comprising: receiving a query regarding a quantity of panels or a quantity of sub-panels that are connected to the RIS controller; and transmitting a response based at least in part on the query, wherein the configuration that indicates the one or multiple on-off patterns is based at least in part on the response.

Aspect 22: The method of any of Aspects 17-21, wherein an on-off pattern, of the one or multiple on-off patterns, is associated with different reflection directions or different beams, and wherein the different reflection directions or the different beams are configured during on states of the one or more panels or the one or more sub-panels.

Aspect 23: The method of any of Aspects 17-22, wherein receiving the configuration that indicates the one or multiple on-off patterns is based at least in part on a dynamic signaling or a semi-static signaling.

Aspect 24: The method of any of Aspects 17-23, wherein the one or multiple on-off patterns include independent on-off patterns for the one or more panels and the RIS controller, and wherein an on-off pattern for the one or more panels is separate from an on-off pattern for the RIS controller.

Aspect 25: The method of any of Aspects 17-24, wherein the one or multiple on-off patterns include dependent on-off patterns for the one or more panels and the RIS controller, and wherein an on-off pattern for the one or more panels is dependent on an on-off pattern for the RIS controller, or the on-off pattern for the RIS controller is dependent on the on-off pattern for the one or more panels.

Aspect 26: The method of any of Aspects 17-25, wherein an on-off pattern of the RIS controller is associated with a same discontinuous reception (DRX) pattern as an on-off pattern of the one or more panels.

Aspect 27: The method of any of Aspects 17-26, wherein an on-off pattern of the RIS controller is based at least in part on the one or more panels and on states associated with the one or more panels, wherein an on state associated with the on-off pattern of the RIS controller is aligned in a time domain with an on state associated with the one or more panels.

Aspect 28: The method of any of Aspects 17-27, wherein an on-off pattern of the RIS controller is based at least in part on the one or more panels and on-off states associated with the one or more panels, wherein an on state associated with the on-off pattern of the RIS controller is not aligned in a time domain to an on-off state associated with the one or more panels.

Aspect 29: The method of any of Aspects 17-28, wherein an on-off pattern of the one or more panels is based at least in part on the RIS controller and on states associated with the RIS controller, wherein an on state associated with the on-off pattern of the one or more panels is aligned in a time domain with an on state associated with the RIS controller.

Aspect 30: The method of any of Aspects 17-29, wherein an on-off pattern, of the one or multiple on-off patterns, indicates that the one or more panels are on during a time in which a user equipment (UE) served by the RIS is scheduled to perform a downlink transmission or an uplink transmission.

Aspect 31: The method of any of Aspects 17-30, wherein receiving the configuration that indicates the one or multiple on-off patterns is based at least in part on a broadcast.

Aspect 32: An apparatus for wireless communication at a device, comprising a processor; memory coupled with the processor; and instructions stored in the memory and executable by the processor to cause the apparatus to perform the method of one or more of Aspects 1-16.

Aspect 33: A device for wireless communication, comprising a memory and one or more processors coupled to the memory, the one or more processors configured to perform the method of one or more of Aspects 1-16.

Aspect 34: An apparatus for wireless communication, comprising at least one means for performing the method of one or more of Aspects 1-16.

Aspect 35: A non-transitory computer-readable medium storing code for wireless communication, the code comprising instructions executable by a processor to perform the method of one or more of Aspects 1-16.

Aspect 36: A non-transitory computer-readable medium storing a set of instructions for wireless communication, the set of instructions comprising one or more instructions that, when executed by one or more processors of a device, cause the device to perform the method of one or more of Aspects 1-16.

Aspect 37: An apparatus for wireless communication at a device, comprising a processor; memory coupled with the processor; and instructions stored in the memory and executable by the processor to cause the apparatus to perform the method of one or more of Aspects 17-31.

Aspect 38: A device for wireless communication, comprising a memory and one or more processors coupled to the memory, the one or more processors configured to perform the method of one or more of Aspects 17-31.

Aspect 39: An apparatus for wireless communication, comprising at least one means for performing the method of one or more of Aspects 17-31.

Aspect 40: A non-transitory computer-readable medium storing code for wireless communication, the code comprising instructions executable by a processor to perform the method of one or more of Aspects 17-31.

Aspect 41: A non-transitory computer-readable medium storing a set of instructions for wireless communication, the set of instructions comprising one or more instructions that, when executed by one or more processors of a device, cause the device to perform the method of one or more of Aspects 17-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a device, comprising:
a memory; and
one or more processors, coupled to the memory, configured to:
transmit a configuration that indicates one or multiple on-off patterns, the one or multiple on-off patterns being associated with one or more of:
one or more panels of a reconfigurable intelligent surface (RIS), one or more sub-panels of the RIS, or an RIS controller; and
receive an indication based at least in part on a receipt of the configuration that indicates the one or multiple on-off patterns.

2. The apparatus of claim 1, wherein an on-off pattern, of the one or multiple on-off patterns, defines time periods associated with one or more of an on state or time periods associated with an off state, with respect to the one or more panels, the one or more sub-panels, or the RIS controller.

3. (canceled)

4. The apparatus of claim 1, wherein an on-off pattern, of the one or multiple on-off patterns, is associated with one of: an RIS controller discontinuous reception (DRX) on-off pattern, an RIS controller discontinuous transmission (DTX) on-off pattern, an RIS panel power on-off pattern, or an RIS panel reflection on-off pattern, and wherein the RIS controller DRX on-off pattern is one of an RIS controller connected mode DRX (C-DRX) on-off pattern or an RIS controller idle mode DRX (I-DRX) on-off pattern.

5. The apparatus of claim 1, wherein the one or more processors are further configured to:
transmit a query regarding a quantity of panels or a quantity of sub-panels that are connected to the RIS controller; and
receive a response based at least in part on the query, wherein the configuration that indicates the one or multiple on-off patterns is based at least in part on the response.

6. (canceled)

7. (canceled)

8. The apparatus of claim 1, wherein
the one or multiple on-off patterns include independent on-off patterns for the one or more panels and the RIS controller, and wherein an on-off pattern for the one or more panels is different from an on-off pattern for the RIS controller, or
the one or multiple on-off patterns include dependent on-off patterns for the one or more panels and the RIS controller, and wherein the on-off pattern for the one or more panels is dependent on the on-off pattern for the RIS controller, or the on-off pattern for the RIS controller is dependent on the on-off pattern for the one or more panels.

9. (canceled)

10. (canceled)

11. (canceled)

12. The apparatus of claim 1, wherein an on-off pattern of the RIS controller is based at least in part on the one or more panels and on-off states associated with the one or more panels, wherein
an on state associated with the on-off pattern of the RIS controller is aligned in a time domain with an on-off state associated with the one or more panels, or
the an on state associated with the on-off pattern of the RIS controller is not aligned in the time domain to the on-off state associated with the one or more panels.

13. The apparatus of claim 1, wherein an on-off pattern of the one or more panels is based at least in part on the RIS controller and on states associated with the RIS controller, wherein an on state associated with the on-off pattern of the one or more panels is aligned in a time domain with an on state associated with the RIS controller.

14. The apparatus of claim 1, wherein an on-off pattern, of the one or multiple on-off patterns, indicates that the one or more panels are on during a time in which a user equipment (UE) served by the RIS is scheduled to perform a downlink transmission or an uplink transmission.

15. (canceled)

16. The apparatus of claim 1, wherein the device is a user equipment (UE) or a network node.

17. An apparatus for wireless communication at a reconfigurable intelligent surface (RIS) controller, comprising:
a memory; and
one or more processors, coupled to the memory, configured to:
receive a configuration that indicates one or multiple on-off patterns, the one or multiple on-off patterns being associated with one or more of:
one or more panels of an RIS associated with the RIS controller, one or more sub-panels of the RIS, or the RIS controller; and
configure the RIS with the one or multiple on-off patterns based at least in part on the configuration that indicates the one or multiple on-off patterns.

18. (canceled)

19. The apparatus of claim 17, wherein an on-off pattern, of the one or multiple on-off patterns, is associated with one of: an RIS controller discontinuous reception (DRX) on-off pattern, an RIS controller discontinuous transmission (DTX) on-off pattern, an RIS panel power on-off pattern, or an RIS panel reflection on-off pattern, and wherein the RIS controller DRX on-off pattern is one of an RIS controller connected mode DRX (C-DRX) on-off pattern or an RIS controller idle mode DRX (I-DRX) on-off pattern.

20. The apparatus of claim 17, wherein the one or more processors are further configured to:
receive a query regarding a quantity of panels or a quantity of sub-panels that are connected to the RIS controller; and
transmit a response based at least in part on the query, wherein the configuration that indicates the one or multiple on-off patterns is based at least in part on the response.

21. The apparatus of claim 17, wherein
the one or multiple on-off patterns include independent on-off patterns for the one or more panels and the RIS controller, and wherein an on-off pattern for the one or more panels is separate from an on-off pattern for the RIS controller, or
the one or multiple on-off patterns include dependent on-off patterns for the one or more panels and the RIS controller, and wherein the on-off pattern for the one or more panels is dependent on the on-off pattern for the RIS controller, or the on-off pattern for the RIS controller is dependent on the on-off pattern for the one or more panels.

22. (canceled)

23. A method of wireless communication performed by a device, comprising:
transmitting a configuration that indicates one or multiple on-off patterns, the one or multiple on-off patterns being associated with one or more of:
one or more panels of a reconfigurable intelligent surface (RIS), one or more sub-panels of the RIS, or an RIS controller; and
receiving an indication based at least in part on a receipt of the configuration that indicates the one or multiple on-off patterns.

24. The method of claim 23, wherein an on-off pattern, of the one or multiple on-off patterns, defines one or more of time periods associated with an on state or time periods associated with an off state, with respect to the one or more panels, the one or more sub-panels, or the RIS controller.

25. The method of claim 23, wherein an on-off pattern, of the one or multiple on-off patterns, is associated with one of: an RIS controller discontinuous reception (DRX) on-off pattern, an RIS controller discontinuous transmission (DTX) on-off pattern, an RIS panel power on-off pattern, or an RIS panel reflection on-off pattern, and wherein the RIS controller DRX on-off pattern is one of an RIS controller connected mode DRX (C-DRX) on-off pattern or an RIS controller idle mode DRX (I-DRX) on-off pattern.

26. The method of claim 23, further comprising:
transmitting a query regarding a quantity of panels or a quantity of sub-panels that are connected to the RIS controller; and
receiving a response based at least in part on the query, wherein the configuration that indicates the one or multiple on-off patterns is based at least in part on the response.

27. A method of wireless communication performed by a reconfigurable intelligent surface (RIS) controller, comprising:
receiving a configuration that indicates one or multiple on-off patterns, the one or multiple on-off patterns being associated with one or more of:
one or more panels of an RIS associated with the RIS controller, one or more sub-panels of the RIS, or the RIS controller; and
configuring the RIS with the one or multiple on-off patterns based at least in part on the configuration that indicates the one or multiple on-off patterns.

28. (canceled)

29. The method of claim 27, wherein an on-off pattern of the RIS controller is based at least in part on the one or more panels and on-off states associated with the one or more panels, wherein
an on state associated with the on-off pattern of the RIS controller is aligned in a time domain with an on-off state associated with the one or more panels, or
the on state associated with the on-off pattern of the RIS controller is not aligned in the time domain to the on-off state associated with the one or more panels.

30. The method of claim 27, wherein an on-off pattern of the one or more panels is based at least in part on the RIS controller and on states associated with the RIS controller, wherein an on state associated with the on-off pattern of the one or more panels is aligned in a time domain with an on state associated with the RIS controller.
